(19) United States
(12) Patent Application Publication
(10) Pub. No.: US 2009/0150439 A1
(43) Pub. Date: Jun. 11, 2009

(54) Common extensible data exchange format

(75) Inventors: Igor Gejdos, Indianapolis, IN (US); Morris J. Young, Indianapolis, IN (US); David Bradley Markisohn, Indianapolis, IN (US); David Patrick Mott, Indianapolis, IN (US); Keith E. Bernard, Fort Wayne, IN (US); Lawrence G. Yarian, II, Auburn, IN (US)

Correspondence Address: BAKER & DANIELS LLP / ROCHE, 300 NORTH MERIDIAN STREET, SUITE 2700, INDIANAPOLIS, IN, 46204, US

(73) Assignee: Roche Diagnostics Operations, Inc., Indianapolis, IN (US)

(21) Appl. No.: 11/999,871

(22) Filed: Dec. 7, 2007

(51) Int. Cl. G06F 17/30

(52) U.S. Cl. 707/104.1; 707/E17.044

(57) ABSTRACT

A medical data system wherein data is exchanged internally and externally by a common data exchange format.

### FIELD OF THE INVENTION

The present disclosure relates to a method and system for managing health data. More particularly, the disclosure relates a method and system for allowing exchange of data between multiple devices.

### BACKGROUND

Many fields of medical treatment and healthcare require monitoring of certain body functions, physical states and conditions, and patient behaviors. Thus, e.g., for patients suffering from diabetes, a regular check of the blood glucose level forms an essential part of the daily routine. The blood glucose level has to be determined quickly and reliably, often several times per day. Medical devices are used to facilitate the collection of medical information without unduly disturbing the lifestyle of the patient. A large number of medical devices for monitoring various body functions are commercially available. Also, medical treatment and healthcare may require monitoring of exercise, diet, meal times, stress, work schedules and other activities and behaviors.

To reduce the frequency of necessary visits to doctors, the idea of home care gained popularity over the recent years. Technological advancements in medicine led to the increased use of medical devices. Many of these medical devices, such as meters and medicine delivery devices, are able to collect and store measurements and other data for long periods of time. Other devices, such as computers, portable digital assistants (PDAs), and cell phones, have been adapted to medical uses by the development of software directed to the collection of healthcare data. These advancements led to the development of health management systems that enable collection and use of large numbers of variables and large amounts of healthcare data. While systems were traditionally developed for use in healthcare facilities and health management organizations including insurance companies and governmental agencies (HCP systems), increased technological sophistication by the populous at large led to the increased use of health management systems by patients, care givers, and others (patient systems) in addition to increased use by HCP systems. U.S. Pat. No. 7,103,578 and U.S. Published Application No. 2004/0172284 disclose two such methods and systems. Many of these systems are able to transfer data between them. Patient healthcare data is often transferred from a patient system to an HCP system. HCP systems may transfer remarks and other data to patient systems or other HCP systems.

### SUMMARY

The disclosure relates to a method and system for interfacing between a healthcare management system and medical devices. One embodiment of the system includes a computer readable medium. The medium including instructions thereon such that when interpreted by a processor cause the processor to perform the steps of extracting medical data from a health management device; transforming the data to an extensible common data format; merging the transformed data into existing stored data to form merged data; and storing the merged data.

In another embodiment, a computer readable medium is provided. The medium including instructions thereon such that when interpreted by a processor cause the processor to perform the steps of extracting medical data from a file created by a health data management system; transforming the data to an extensible common data format; merging the transformed data into existing stored data to form merged data; and storing the merged data.

In yet another embodiment, a computer readable medium is provided. The medium including instructions thereon such that when interpreted by a processor cause the processor to perform the steps of establishing a business logic component and a connectivity component; obtaining medical data; formatting the medical data into a file having an extensible common data format; and transmitting the file between the business logic and connectivity components.

### DESCRIPTION OF THE DRAWINGS

For more complete understanding of the present disclosure, reference is established to the following drawings in which:

FIG. 1 shows an embodiment of a health management system comprising first and second healthcare systems;

FIG. 2 is a first block diagram of interactions between components within the healthcare systems of FIG. 1;

FIG. 3 is second block diagram of interactions between components within the healthcare systems of FIG. 1; and

FIG. 4 is a schematic of a top level element for a format used in the health management system of FIG. 1.

Corresponding reference characters indicate corresponding parts throughout the several views. Although the drawings represent embodiments of various features and components according to the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF EMBODIMENTS OF THE INVENTION

For the purposes of promoting an understanding of the principles of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the invention is thereby intended. The disclosure includes any alterations and further modifications in the illustrated devices and described methods and further applications of the principles of the disclosure which would normally occur to one skilled in the art to which the disclosure relates.

The invention is described herein with reference to healthcare data management software, and more particularly, with reference to diabetes management software, although the invention may be applied, generally, to data management systems in fields unrelated to healthcare management.

The terms “network,” “local area network,” “LAN,” “wide area network,” or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. The computers have at least one processor for executing machine instructions, and memory for storing instructions and other information. Many combinations of processing circuitry and information storing equipment are known by those of ordinary skill in these arts. A processor may be a microprocessor, a digital signal processor (“DSP”), a central processing unit (“CPU”), or other circuit or equivalent capable of interpreting instructions or performing logical actions on information. Memory includes both volatile and non-volatile memory, including temporary and cache, in electronic, magnetic, optical, printed, or other format used to store information. Users activate computer programs or network resources to create “processes” which include both the general operation of the computer program along with specific operating characteristics determined by input variables and its environment.

Concepts described below may be further explained in one of more of the co-filed patent applications entitled HELP UTILITY FUNCTIONALITY AND ARCHITECTURE (Atty Docket: ROCHE-P0033), METHOD AND SYSTEM FOR GRAPHICALLY INDICATING MULTIPLE DATA VALUES (Atty Docket: ROCHE-P0039), SYSTEM AND METHOD FOR DATABASE INTEGRITY CHECKING (Atty Docket: ROCHE-P0056), METHOD AND SYSTEM FOR DATA SOURCE AND MODIFICATION TRACKING (Atty Docket: ROCHE-P0037), PATIENT-CENTRIC HEALTHCARE INFORMATION MAINTENANCE (Atty Docket: ROCHE-P0043), EXPORT FILE FORMAT WITH MANIFEST FOR ENHANCED DATA TRANSFER (Atty Docket: ROCHE-P0044), GRAPHIC ZOOM FUNCTIONALITY FOR A CUSTOM REPORT (Atty Docket: ROCHE-P0048), METHOD AND SYSTEM FOR SELECTIVE MERGING OF PATIENT DATA (Atty Docket: ROCHE-P0065), METHOD AND SYSTEM FOR PERSONAL MEDICAL DATA DATABASE MERGING (Atty Docket: ROCHE-P0066), METHOD AND SYSTEM FOR WIRELESS DEVICE COMMUNICATION (Atty Docket: ROCHE-P0034), METHOD AND SYSTEM FOR SETTING TIME BLOCKS (Atty Docket: ROCHE-P0054), METHOD AND SYSTEM FOR ENHANCED DATA TRANSFER (Atty Docket: ROCHE-P0042), METHOD OF CLONING SERVER INSTALLATION TO A NETWORK CLIENT (Atty Docket: ROCHE-P0035), METHOD AND SYSTEM FOR QUERYING A DATABASE (Atty Docket: ROCHE-P0049), METHOD AND SYSTEM FOR EVENT BASED DATA COMPARISON (Atty Docket: ROCHE-P0050), DYNAMIC COMMUNICATION STACK (Atty Docket: ROCHE-P0051), SYSTEM AND METHOD FOR REPORTING MEDICAL INFORMATION (Atty Docket: ROCHE-P0045), METHOD AND SYSTEM FOR MERGING EXTENSIBLE DATA INTO A DATABASE USING GLOBALLY UNIQUE IDENTIFIERS (Atty Docket: ROCHE-P0052), METHOD AND SYSTEM FOR ACTIVATING FEATURES AND FUNCTIONS OF A CONSOLIDATED SOFTWARE APPLICATION (Atty Docket: ROCHE-P0057), METHOD AND SYSTEM FOR CONFIGURING A CONSOLIDATED SOFTWARE APPLICATION (Atty Docket: ROCHE-P0058), METHOD AND SYSTEM FOR DATA SELECTION AND DISPLAY (Atty Docket: ROCHE-P0011), METHOD AND SYSTEM FOR ASSOCIATING DATABASE CONTENT FOR SECURITY ENHANCEMENT (Atty Docket: ROCHE-P0041), METHOD AND SYSTEM FOR CREATING REPORTS (Atty Docket: ROCHE-P0046), METHOD AND SYSTEM FOR CREATING USER-DEFINED OUTPUTS (Atty Docket: ROCHE-P0047), DATA DRIVEN COMMUNICATION PROTOCOL GRAMMAR (Atty Docket: ROCHE-P0055), HEALTHCARE MANAGEMENT SYSTEM HAVING IMPROVED PRINTING OF DISPLAY SCREEN INFORMATION (Atty Docket: ROCHE-P0031), and METHOD AND SYSTEM FOR MULTI-DEVICE COMMUNICATION (Atty Docket: ROCHE-P0064), the entire disclosures of which are hereby expressly incorporated herein by reference. It should be understood that the concepts described below may relate to diabetes management software systems for tracking and analyzing health data, such as, for example, the Accu-Chek® 360° product provided by Roche Diagnostics. However, the concepts described herein may also have applicability to apparatuses, methods, systems, and software in fields that are unrelated to healthcare. Furthermore, it should be understood that references in this patent application to devices, meters, monitors, pumps, or related terms are intended to encompass any currently existing or later developed apparatus that includes some or all of the features attributed to the referred to apparatus, including but not limited to the Accu-Chek® Active, Accu-Chek® Aviva, Accu-Chek® Compact, Accu-Chek® Compact Plus, Accu-Chek® Integra, Accu-Chek® Go, Accu-Chek® Performa, Accu-Chek® Spirit, Accu-Chek® D-Tron Plus, and Accu-Chek® Voicemate Plus, all provided by Roche Diagnostics or divisions thereof.

As used herein the term “Common Data Format” (CDF) refers to a specification that describes the structure of data used to exchange data between components of a system and between the system and other medical information systems. CDF also refers to a file that conforms to the above described specification. CDF 300 utilizes Extensible Markup Language (XML) which is a specification developed by the W3C that defines a markup language used to describe the structure of data in a platform-independent way. However, the present CDF 300 is not intended to be limited to instances including XML. An XML Schema is a specification developed by the W3C that defines an XML language used to define and document the structure of an XML document and to impose constraints on the content of the XML document. An XML Schema Definition (XSD) is an instance of the XML Schema specification that defines a specific structure for XML documents.

The terms Extract, Transform and Load, abbreviated herein as “ETL” are discussed in the context of data warehousing. ETL is the process of extracting data from a system then transforming and loading that data into another system.

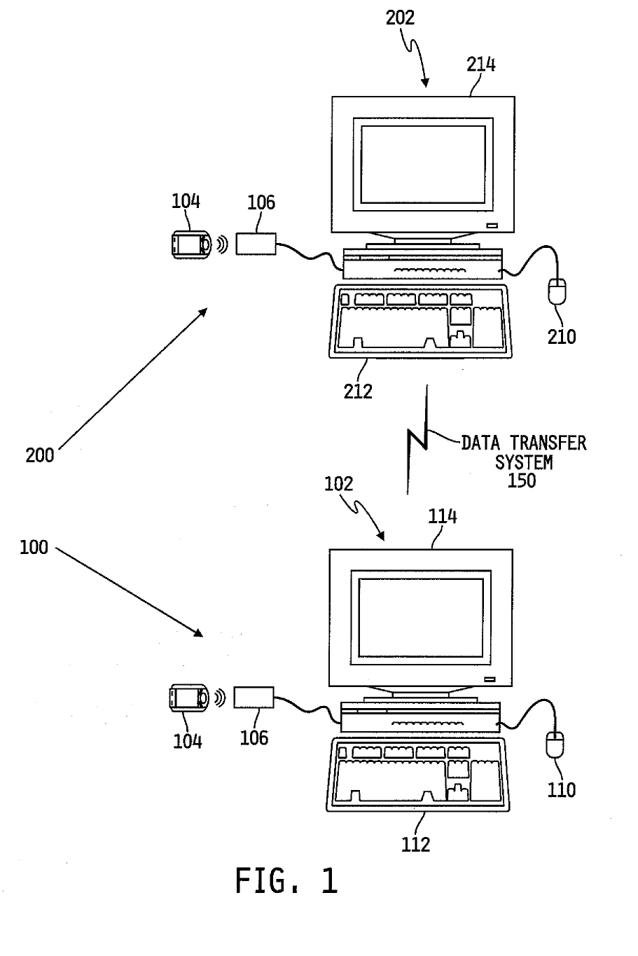

Turning now to the figures, FIG. 1 depicts an exemplary embodiment of first healthcare system 100 and second (external) healthcare system 200 connected via a WAN 150 for monitoring data. Systems 100, 200 each comprise a computing device, shown here in the form of computers 102, 202 having processing units, system memory, display devices 114, 214, and input devices 112, 212, 110, 210, 106. Healthcare computer 202 may be, but is not necessarily, acting as a server. Furthermore, while only two computers 102, 202 are shown, many more computers may be part of the overall system.

While standard input devices such as mice 110, 210 and keyboards 112, 212 are shown, systems 100, 200 may comprise any user input device. By example, infrared (IR) dongle 106 is coupled to each of computers 102, 202. IR dongle 106 is configured to send and receive IR transmissions from health management device 104. Computers 102, 202 include software applications 320 configured to receive data from health management device 104 via IR dongle 106 or otherwise. While the use of IR and IR dongles is disclosed herein for the transmission of data between health management device 104 and computers 102, 202, any other method of wireless transmission is also envisioned, including but not limited to RF. Systems 100, 200 include health management software 320 configured to receive medical information from one or more of input devices 112, 212, 110, 210, 106. Health management devices 104 are described herein as meters, but could also be a PDA, therapeutic pump, combinations thereof, or other devices that store medical data thereon. Medical information may include blood glucose values, A1c values, Albumin values, Albumin excretion values, body mass index values, blood pressure values, carbohydrate values, cholesterol values (total, HDL, LDL, ratio) creatinine values, fructosamine values, HbA1 values, height values, insulin dose values, insulin rate values, total daily insulin values, ketone values, microalbumin values, proteinuria values, heart rate values, temperature values, triglyceride values, weight values, and any other medical information that is desired to be known.

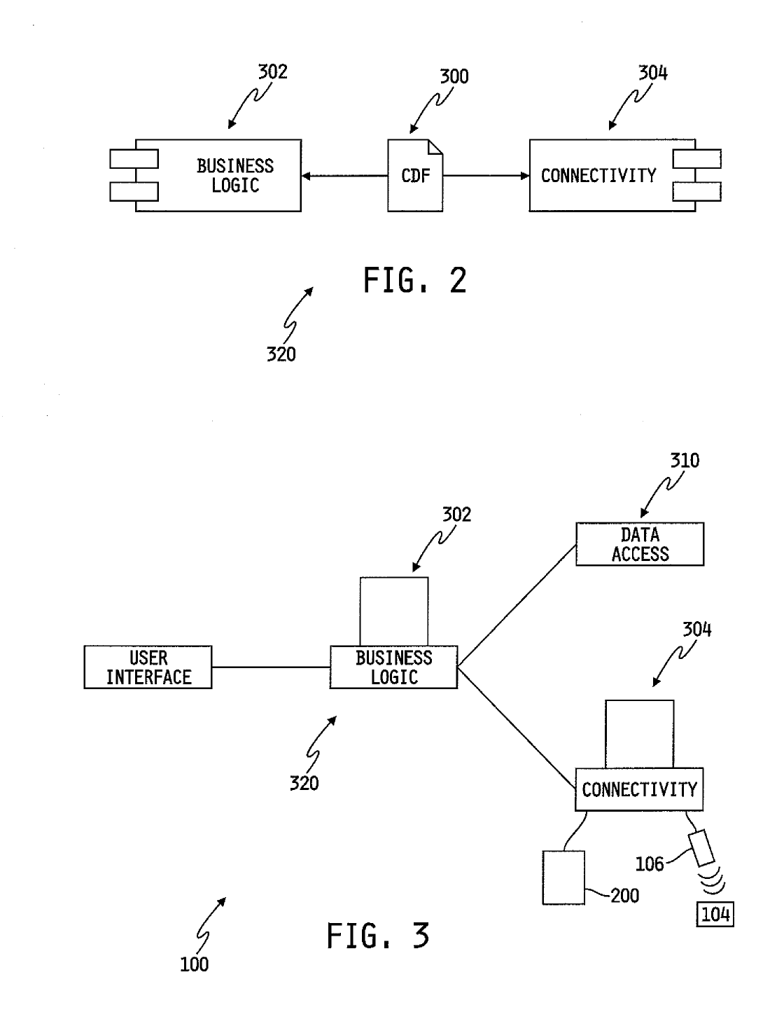

Program 320 is provided to manage medical information on system 100 (and on system 200 in some embodiments). XML based CDF 300 allows information to be passed between Business Logic component 302 and Connectivity component 304, FIG. 2, when information is exchanged between the program 320 and external data sources. The information to be shared can originate from health management devices 104, such as glucose meters, containing a glucose measurement engine, used by people with diabetes to manage their disease, and from other medical information systems 200. The information can also be entered into program 320 such that the information originates within program 320 for use by medical information systems 100, 200. The Business Logic 302 and Connectivity 304 components of program 320 use CDF-compliant XML to exchange information with each other and external data sources.

Within program 320, CDF-compliant XML is exchanged between the Business Logic component 302 and Connectivity component 304 when obtaining information from connected health management devices 104. When requested by Business Logic component 302, Connectivity component 304 extracts data from connected health management device 104 and translates this information from the device's format into CDF-compliant XML. The information is returned to the Business Logic component 302 where it is validated for conformance to the CDF specification. If the XML structure is valid, the Business Logic 302 component merges the data with the existing data in the data store 310 and loads the new data into data store 310. This process is presented in FIG. 3 using health management device 104.

The program 320 can import data from external files generated by other systems 200. When requested by Business Logic component 302, Connectivity component 304 reads the data from the file and translates the information from the file format into CDF-compliant XML. The information is returned to Business Logic component 302 where it is validated for conformance to the CDF specification. If the XML structure is valid, the data in CDF 300 is merged with existing data in the program data store 310. This process is presented in FIG. 3 using external system 200.

Because XML is a text-oriented, document-centric technology, it naturally supports storage in electronic files. Program 320 is capable of importing CDF-compliant XML data from electronic files. When importing CDF formatted data from a file, the transformations are not performed. This program function can be used to incorporate data into the system 100 from other systems 200 capable of producing CDF compliant XML documents.

Program 320 can export internal data to other formats for data exchange with other systems. In this scenario, it is the responsibility of Business Logic component 302 to extract the data from data store 310 and generate CDF-compliant XML with this data. Once the XML structure is created, Business Logic component 302 provides it to Connectivity component 304 where it is validated for conformance to the CDF specification. If the XML structure is valid, the data is transformed into the target file format and written to a file.

The extract, transform and load (ETL) process involves retrieving data from external system 200, transforming (and optionally cleansing) the data into the appropriate format, if necessary, for target system 100 and then loading that information into target system 100. The processes used to obtain data from connected health management devices 104 and importing data from files are forms of the ETL process. The ETL process within program 320 also includes the retrieval of data in other medical information systems 200.

The process of exporting data from program 320 to external system 200 is limited to the file export process. Program 320 does not take responsibility for loading data into the external system 200. Therefore, program 320 performs the extract and transform steps of ETL when preparing data for use by external systems 200.

When importing data, the Connectivity component 304 of program 320 extracts the data from the external system 20 or file. When exporting data for use by an external medical system 200, the Business Logic component 302 extracts the data from data store 310. The data is manipulated into CDF-compliant XML in the Business Logic 302 for further processing within the Connectivity component 304

After extracting the data, Connectivity component 304 transforms the data into CDF-compliant XML for use by Business Logic component 302. Connectivity component 304 transforms the CDF-compliant XML into the appropriate file format when exporting data for use by external system 200.

When the Business Logic component 302 receives CDF-compliant XML from Connectivity component 304, Business Logic component 302 merges information in the structure with information in data store 310, resolving any conflicts that may exist. After the incoming data is merged with the existing data, it is written to data store 310.

When exporting data to file for use by external medical system 200, Connectivity component 304 transforms the data into the appropriate format and then saves it to file.

CDF 300 is extensible with respect to the addition of user-defined types. User-defined types are specified in CDF 300 instance (XML document) and require no changes to the CDF schema. Example extensible user-defined types are Health Care Professionals, Event Qualifiers, Ethnicity Types, Result Qualifiers, Data Types, and Medications.

User-defined types are defined in a DataDefinitions section of CDF 300, and are referenced by their Global UID (GUID). The Global UID is generated by the producer of CDF 300, according to an algorithm that guarantees uniqueness in both time and space. The format is a string that contains a globally unique identifier as 32 contiguous digits: DDDDDDDDDDDDDDDDDDDDDDDDDDDDDDDD; where ‘D’ represents a hexadecimal digit in upper case. An example of an algorithm for creating a Globally Unique ID's is Microsoft GUID algorithm.

Once a user-defined type is assigned a Global UID, that Global UID is used to reference definition of the type throughout CDF document 300. If the source of CDF data maintains consistent Global UID for user defined types, it can help identify such types correctly and consistently between CDF documents 300. This is not always possible with legacy data sources that do not use Global UID.

CDF 300 has built-in data types and is extensible with respect to the addition of built-in data types. Such additions require a new release of the CDF schema that is compatible with previous versions. All built-in types are referenced by their TypeKey. A TypeKey is a member of an enumerated list such as the previously discussed list of Health Care Professionals, Event Qualifiers, Ethnicity Types, Result Qualifiers, Data Types, and Medications. Once a built-in type is assigned a TypeKey, its definition is not changed.

CDF 300 is extensible with respect to enumerated list items. The addition of enumerated list items does not prevent backward compatibility.

CDF 300 is extensible with respect to new devices. CDF 300 employs globally recognized concepts in its data definitions that support straightforward mapping from new device data to CDF 300.

CDF 300 provides for the specification of information that has no intrinsic meaning to the system, but may still add value for the user. This information is stored as localized or non-localized text. The text is stored in the current language (localization) of the tool. It is displayed in that same language, even on tools whose localization is different from that of the tool that generated CDF instance document 300.

CDF 300 further has target namespace. Target namespace is the namespace where the newly created elements and attributes reside. Target namespace is referred from the XML instance for ensuring validity of the instance document. During validation, a validator verifies that the elements/attributes used in the instance exist in the declared namespace, and also checks for any other constraint on their structure and datatype. CDF 300 has a “wildcard” element to allow third party application data.

The CDF schema is versioned. The version is documented in the top-level schema element. An exemplary version numbering system includes a namespace number, a major version number, a minor version number, and a maintenance version number. There is one version number for the entire CDF schema. Versioning of the schema provides backward compatibility as the schema evolves over its lifetime. This is accomplished by having all instances of the CDF schema (XML documents) specify a version attribute in the top-level element of CDF 300.

Backward compatibility is further achieved by having CDF 300 versions that differ only by their minor or maintenance version numbers be guaranteed to be backward compatible (i.e., a tool that supports the newer version will always be able to import data from a source which exports to CDF 300 with the older version).

Backward compatibility is still further achieved by having CDF versions that differ by their major version number be supported by the tool. The tool loads an import module that uses the newest CDF schema for that major revision number in order to import the data. Because major revisions involve structural changes, a separate import module is needed for each major revision of CDF 300. By default, tools export to the latest version of CDF 300. If it becomes necessary to export to older versions of CDF 300, then the tool loads an export module that uses the newest CDF schema for that major revision number in order to export the data. Because major revisions involve structural changes, a separate export module is needed for each major revision of CDF 300.

Enumerated types in the schema are defined in a separate schema file. This enhances maintainability of the schema as additional values are added to an enumerated type. The schema defines a content model that supports the exchange of results even when these results cannot be immediately associated with a person.

The schema defines a content model consisting of all information needed to interpret the results in the schema and to associate these results with a person. The content model allows user-defined type definitions to be included when user-defined type definitions are required to interpret the data. When obtaining information from a device, the content model requires enough information from the device to uniquely identify the device. Associating these results with the appropriate person is an exercise of determining the person associated with the device.

The schema defines a content model consisting of only the information needed to interpret the results and to associate these results with a person. Information not relevant to interpretation of the results is omitted from the schema.

When exchanging CDF-compliant XML between components, the structure of the XML contains all required content defined in the CDF specification, not individual data types defined within the specification. This supports validation of the XML against the CDF schema. Any component that uses data within CDF-compliant XML first validates the structure against the CDF schema to verify the structure's compliance with the CDF specification.

The formatting of data within CDF 300 includes many parameters. If a health management device 104 or other device is the origin of data in CDF 300, a unique record identifier identifies the most recent record retrieved from the device. This identifier is conveyed in CDF 300. If a device is the origin of data in CDF 300, the internal device date and time is communicated with device information. Information that could be missing in the data source (i.e., date and time) is optional in CDF 300. For information that could be incomplete or invalid according to the CDF 300 in the data source, CDF 300 allows for the specification of invalid or incomplete data. Measurement data is transferable even when the date is missing, incomplete, or invalid.

The scope of transferred data includes: information about data origin (device, external system, etc.); medical data communicated during device download including program native file import/export, legacy file import, and import from external systems; collateral data required to define patient results; events and results; data type definitions required for exported results; medications associated to exported patients and/or results; visit notes associated to exported results and events; devices definitions associated with exported patients; patient name, DOB and administrative data; groups to which exported patient belongs (including definition); physicians and their information associated with exported patients.

In one embodiment, CDF specification 300 is purely a data format isolated from a command part of any interface that uses the format to provide data into the software 320. This embodiment has no interface commands in CDF 300.

If CDF 300 is embedded in a larger interface definition, then the interface provides means to isolate CDF 300 from the interface. For example, if CDF 300 is further wrapped in other XML tags, then the interface provides means to isolate the conforming CDF data from this interface.

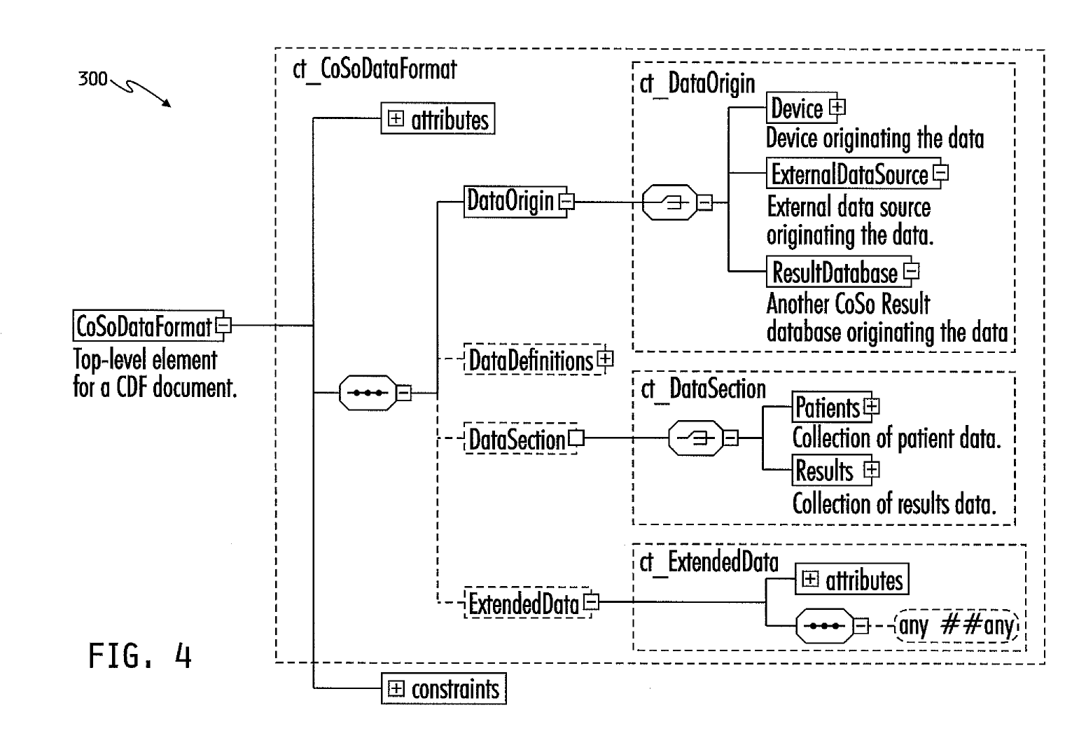

The top level structure of CDF 300 includes four sections: Data Origin, Data Definitions, Data Section and Extended Data, as shown in FIG. 4. FIG. 4 illustrates these sections as defined in the XML schema. How these sections are utilized in various situations is described in Table 1.

Data originating from a single patient device will have Data Origin filled with device information including latest downloaded record identifier, device level flags, etc. If there is only need for the device information, then the data section and definitions can be left empty.

Native file format uses the result database as data origin. The result database has information about the database creation date and schema version from which the data originate. This information may be potentially useful for import from files created by older program versions.

TABLE 1
Scenarios of utilization for CDF sections

| | Data | Data | Data | Extended |
|---|---|---|---|---|
| Scenario | Origin | Definitions | Section | Data |
| Data download from | Device | YES | Results | N/A |
| a single patient device | | | | |
| Data import/export | Result | YES | Patients | N/A |
| to native file format | Database | | | |
| Data import from | External | YES | Patients¹ | N/A |
| legacy files, legacy | Data | | | |
| databases, HIS and | Source | | | |
| LIS and potentially | | | | |
| other external data | | | | |
| sources. | | | | |
| Data inserted by other | N/A | N/A | N/A | Data |
| applications | | | | |

¹Data import from external data sources allows definition of external patient identity for each patient if the download is repeated in the future.

When implemented, patient data is collected from devices, external systems and exports from another program database. Data from various sources are mainly represented as results and events. Results represent medical data values while events represent patient related activities such as exercise, prescriptions, and office visits. The data store 310 and external systems associate results with a patient or device as in case of the communication with devices. This is because the device does not have the patient information and results are later associated with the patient. The character of collected results is determined by the ResultType and includes: Measurements—from devices, data acquisition systems or manual entry, Universal Pump Record—device performance log of insulin pumps, and Advised values—data values recommended to patient (for example, insulin dose).

The Result entity is configurable to represent a variety of collected values. The association with DataType determines the data type of collected value and the DataValue attribute holds actual value, for example, a measured amount of blood glucose. A ResultQualifier entity allows assignment of enumerated property to the result. For example, the blood glucose measurement may have an indication that control solution was used instead of a blood sample or the value might be above range. In such cases, the ResultQualifier represents the type of control solution used or an “Above Range” indication. In another example, an insulin injection can have an associated ResultQualifier insulin type that was actually injected by the patient.

Data, once received, is mapped into CDF 300. Individual device data items fall under the following distinct categories: Result, Result qualifier, User defined Result qualifier, patient event, and Device. Result is defined as an element in CDF 300. Built in result qualifiers are predefined as enumerations so there is no need to define them in the Data Definitions section. They are referenced by Type Key in CDF 300. User defined result qualifier is defined in the Data Definitions section, and assigned to a Global UID. The defined result qualifier can then reference this Global UID in CDF 300. The Global UID assigned to the qualifier remains the same is such clarifier is defined repeatedly. For example, if a library defines “Post Meal” qualifier of type “cdf.rqtype.device.event,” then the next time this qualifier is defined (e.g., when downloading another device) the same Global UID is used. This helps to identify that result qualifier in the database. Custom Names with the same meaning but different Custom Name (for example, in another language) are considered identical qualifiers and have the same Global UID assigned. The patient event is used to represent exercise.

Table 2 provides a partial list of examples of how these categories can be used to implement device data using a glucose meter as an exemplary device. Measurements fit within the Result framework and the device information is under Device. Table 3 is a partial list of examples of possible device flags and events in CDF 300, again using a glucose meter as an exemplary device.

TABLE 2
Representing Device Data in CDF

| Device | | | |
|---|---|---|---|
| Data | Result | Device | Element Details |
| Device | | X | SerialNumber |
| Model, and | | | The serial number |
| Serial | | | DeviceModel |
| Number | | | The model of device |
| Glucose | X | | ResultType: |
| value | | | cdf.res.measurement |
| | | | DataType: |
| | | | cdf.dat.bg |
| | | | DataValue: |
| | | | Value of measured data |
| Ketones | X | | ResultType: |
| | | | cdf.res.measurement |
| | | | DataType: |
| | | | cdf.dat.ketones |
| | | | DataValue: |
| | | | Value of measured data |

TABLE 3
Representing Device Flags and Events in CDF

| Device | Built In | User | | |
|---|---|---|---|---|
| Flag or | Result | Defined | Patient | |
| Event | Qualifier | Result | Event | Element Details |
| Result | X | | | TypeKey: |
| too low | | | | cdf.resq.result.flag.range.below |
| Result | X | | | TypeKey: |
| too high | | | | cdf.resq.result.flag.range.above |
| Result | | | | TypeKey: |
| deleted | | | | cdf.resq.result.flag.deleted |

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A computer readable medium, including instructions thereon such that when interpreted by a processor cause the processor to perform the steps of:
extracting medical data from a health management device;
transforming the data to an extensible common data format;
merging the transformed data into existing stored data to form merged data; and
storing the merged data.

2. The computer readable medium of claim 1, wherein the extensible common data format is XML based.

3. The computer readable medium of claim 1, wherein the extracting step includes extracting medical data from a device having a glucose measurement engine.

4. The computer readable medium of claim 1, wherein the instructions include a set of business rules and a set of connectivity instructions, the connectivity instructions causing the processor to perform the extracting and transforming steps before the business rules cause the processor to perform the merging step.

5. The computer readable medium of claim 1, further including instructions such that when interpreted by a processor cause the processor to perform the steps of:
extracting merged data from storage;
creating a document in the extensible common data format including at least some of the merged data; and
exporting the created document into a file.

6. The computer readable medium of claim 1, further including instructions such that when interpreted by a processor cause the processor to perform the step of validating the data in the common data format against a schema before the merging step.

7. The computer readable medium of claim 1, wherein the extracting step is performed via wireless transmission.

8. The computer readable medium of claim 7, wherein the extracting step is performed via IR transmission.

9. The computer readable medium of claim 7, wherein the extracting step is performed via RF transmission.

10. A computer readable medium, including instructions thereon such that when interpreted by a processor cause the processor to perform the steps of:
extracting medical data from a file created by a health data management system;
transforming the data to an extensible common data format;
merging the transformed data into existing stored data to form merged data; and
storing the merged data.

11. The computer readable medium of claim 10, wherein the extensible common data format is XML based.

12. The computer readable medium of claim 10, wherein the extracting step includes extracting medical data from a file having data therein generated by a glucose measurement engine.

13. The computer readable medium of claim 10, wherein the instructions include a set of business rules and a set of connectivity instructions, the connectivity instructions causing the processor to perform the extracting and transforming steps before the business rules cause the processor to perform the merging step.

14. The computer readable medium of claim 10, further including instructions such that when interpreted by a processor cause the processor to perform the steps of:
extracting merged data from storage;
creating a document in the extensible common data format including at least some of the merged data; and
exporting the created document into a file.

15. The computer readable medium of claim 10, further including instructions such that when interpreted by a processor cause the processor to perform the step of validating the data in the common data format against a schema before the merging step.

16. A computer readable medium, including instructions thereon such that when interpreted by a processor cause the processor to perform the steps of:
establishing a business logic component and a connectivity component;
obtaining medical data;
formatting the medical data into a file having an extensible common data format; and
transmitting the file between the business logic and connectivity components.

17. The computer readable medium of claim 16, wherein the extensible common data format is XML based.

18. The computer readable medium of claim 16, wherein the obtaining step includes extracting medical data from a file.

19. The computer readable medium of claim 16, wherein the obtaining step includes extracting medical data from a device having a glucose measurement engine.

20. The computer readable medium of claim 16, wherein the connectivity component includes instructions causing the processor to perform the obtaining and formatting steps.

21. The computer readable medium of claim 16, further including instructions such that when interpreted by a processor cause the processor to perform the steps of:
extracting merged data from storage;
creating a document in the extensible common data format including at least some of the merged data; and
exporting the created document into a file.

22. The computer readable medium of claim 16, further including instructions such that when interpreted by a processor cause the processor to perform the steps of:
validating the data in the common data format against a schema; and
merging the validated medical data with existing previously validated medical data.

23. The computer readable medium of claim 16, wherein the business rules component includes instructions causing the processor to perform the obtaining and formatting steps.
